(19) United States
(12) Patent Application Publication
(10) Pub. No.: US 2007/0190288 A1
(43) Pub. Date: Aug. 16, 2007

(54) Multi-layered colored paper

(75) Inventor: Tai-Cheng You, Pu-Li Tsien (TW)

Correspondence Address: BRUCE H. TROXELL, SUITE 1404, 5205 LEESBURG PIKE, FALLS CHURCH, VA, 22041, US

(73) Assignee: Shin Kwang Hwa Paper Mfg. Co., Ltd.

(21) Appl. No.: 11/354,848

(22) Filed: Feb. 16, 2006

(51) Int. Cl. B32B 5/12

(52) U.S. Cl. 428/113; 428/537.5

(57) ABSTRACT

A multi-layered colored paper includes at least three layers of different colored papers. Each layer has a preset area with fibers on its surface intertwining with those of another neighboring layer. At first the three layers are superposed on one another in a half dried condition, letting the half wet fibers intertwined with one another not stably. After dried, the fibers of two neighboring layers intertwine stably with one another so that the three layers may be easily peeled off from each other, and not to move, slide or shift from each other during engraving.

### BACKGROUND OF THE INVENTION

1. Field of the Invention

This invention relates to paper, particularly to one composed of plural layers of colored paper with fibers intertwined with one another between two layers after dried by superposing the plural layers of colored paper one another while they are half dried, so fibers of the surface of every two layers may intertwined stably with one another after dried, enabling any layer to peel easily from each other.

2. Description of the Prior Art

Among traditional crafts, paper engraving is performed to various colored papers placed overlapped, with an engraving knife cutting off the various colored papers in different depth so that the engraved colored papers may become a kind of engraved artifact with various colors.

However, the overlapped colored papers used in the conventional paper engraving are not kept stable or adhered in any degree, with the friction between each layer of colored paper almost not existing. Then the colored papers with the plural layers may always shift or move from each other during engraving, harming the interest of engraving, and in addition, often leading to a failed finished artifact.

### SUMMARY OF THE INVENTION

The feature of the invention is a colored paper composed at least of three different colored papers superposed, and each two neighboring layers have their certain area provided with fibers intertwined stably with one another after dried, and at first the three layers of the colored papers are superposed each other in a half dried condition. So after dried, the three layers of colored papers may become stable by the intertwined fibers between every two layers. Then the layers of colored papers may not slide, move or shift from each other during engraving, facilitating engraving work, and each layer may be easily peeled off from each other, as the intertwining force of the fibers are not so strong.

### BRIEF DESCRIPTION OF DRAWINGS AND ENCLOSED PICTURES

This invention will be better understood by referring to the accompanying drawings and the enclosed pictures, wherein:

FIG. 1 is a perspective view of a multi-layered colored paper in the present invention;

FIG. 2 is a partial cross-sectional view of the multi-layered colored paper in the present invention;

FIG. 3 is a perspective view of the multi-layered colored paper in the present invention, showing it engraved with partial portions of the colored paper removed.

Enclosed 1 is a picture of the multi-colored paper in the invention being engraved practically; and

Enclosed 2 is a picture of the multi-layered colored paper being engraved in another way.

### DETAILED DESCRIPTION OF THE PREFERRED EMBODIMENT

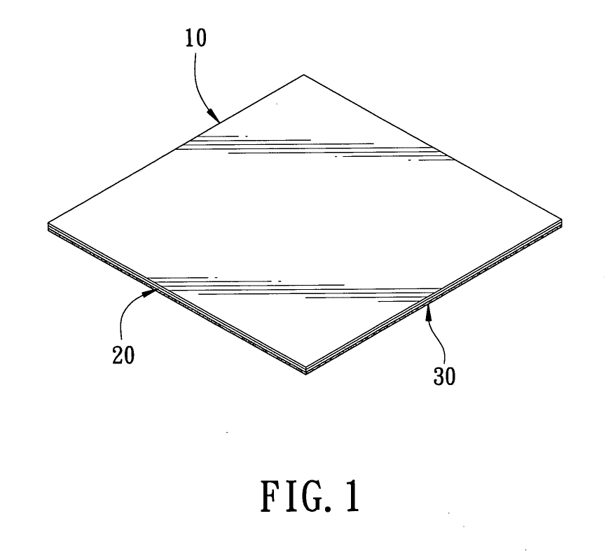

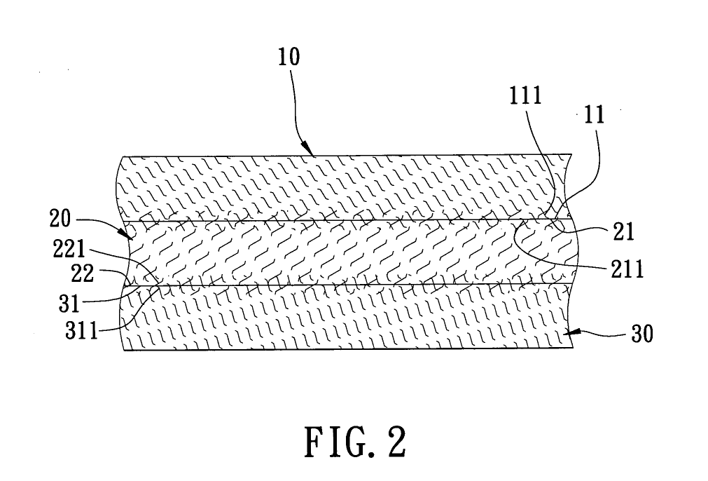

A preferred embodiment of a multi-layered colored paper in the present invention, as shown in FIGS. 1 and 2, includes an upper layer 10, a medium layer 20 and a lower layer 30, and all the layers have different colors from each other. Every two neighboring layers of the colored paper have a certain area with fibers on the surface of the two layers intertwined with one another after superposed together in a half dried condition.

Further, during the half dried condition, the lower surface 11 of the upper layer 10 have fibers 111 and the upper surface 21 of the medium layer 20 has fibers 211, and the fibers 111 and 211 intertwine with one another in a not-yet stable condition. So the fibers 221 on the lower surface 22 of the medium layer 20 and the fibers 311 of the upper layer 31 of the lower layer 30 intertwine with one another. But after dried completely, those fibers 111, 211 and 311 of the three layers 10, 20 and 30 may intertwined somewhat stably with one another, enabling the all three layers 10, 20 and 30 kept in a stable condition in some degrees after dried completely.

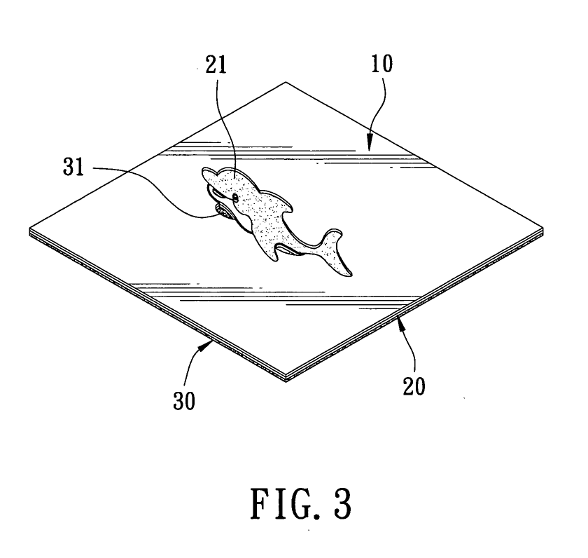

Next, when a user carries out engraving on the multi-layered colored paper, as shown in FIG. 3, it cannot slide, move or shift from each other because of the lower surface 11 of the upper layer 10 and the upper surface of the medium layer 20 are kept stable by the intertwined fibers, and so are the lower surface 22 of the medium layer 20 and the upper surface 31 of the lower layer 30. Further, if the upper layer 10 is needed to be peeled off the medium layer 20 during the process of engraving, it can be effected by separating the fibers of the lower surface 11 of the upper layer 10 from those of the upper surface 21 of the medium layer 20, or separating the fibers of the lower surface 22 of the medium layer 20 from those of the upper surface 31 of the lower layer 30. Moreover, separating the fibers is easy, as there is no glue used.

The invention has the following advantages.
1. The intertwined fibers can keep the three layers of the color paper stable not easily moved during the process of engraving, enhancing successful percentage of engraving.
2. The three layers of the colored paper can be easily separated from each other, never making damage to any layer of the colored paper, very convenient for use.

While the preferred embodiment of the invention has bee described above, ii will be recognized and understood that various modifications may be made therein and the appended claims are intended to include all such modifications that may fall within the spirit and scope of the invention.

What is claimed is:

1. A multi-layered colored paper comprising at least three layers of differently colored papers, said each layer superposed one another with fibers on contacting surfaces of every two neighboring layers intertwining one another in a half dried condition first to let said fibers on contacting surfaces of two neighboring layers intertwining stably with one another after dried completely, said three layers becoming stable not to slide, move or shift from each other after dried and possible to be easily peeled from each other.
